(19) United States
(12) Patent Application Publication
(10) Pub. No.: US 2013/0266685 A1
(43) Pub. Date: Oct. 10, 2013

(54) DRINK SAMPLE APPARATUS AND METHOD OF USE

(71) Applicant: Jose Santiago, Sugar Hill, GA (US)

(72) Inventor: Jose Santiago, Sugar Hill, GA (US)

(21) Appl. No.: 13/676,623

(22) Filed: Nov. 14, 2012

Related U.S. Application Data
(60) Provisional application No. 61/621,307, filed on Apr. 6, 2012.

(51) Int. Cl. A23L 1/22

(52) U.S. Cl. CPC A23L 1/22
USPC 426/2; 426/132; 426/87

(57) ABSTRACT

A drink sample apparatus having an elongated stick, an indicia of the drink mixture marked on said stirring stick, a small mixture of an mixed drink or oil extract of the same, an edible bond to affix or cover said small mixture of an alcohol drink to said stirring stick that functions to provide a sample taste of a drink or beverage before making the decision to purchase the drink or beverage.

### CROSS REFERENCE TO RELATED APPLICATIONS

To the full extent permitted by law, the present U.S. Non-Provisional patent application claims priority to and the full benefit of United States Provisional patent application entitled “Mixer Liquor Drink Sample on a Stick”, filed on Apr. 6, 2012, having assigned Ser. No. 61/621,307, incorporated entirely herein by reference in its entirety.

### TECHNICAL FIELD

The disclosure relates generally to drink products and more specifically it relates to a sample or taster stick for a specific beverage and still more particularly the disclosure relates to preselected flavor(s) bonded or laminated to the sample stick.

### BACKGROUND

Different beverages and packaging for beverages are known in the prior art. For example, there are different flavored of alcoholic beverages, sodas, fruit drinks, teas, beers, sports drinks, coffees, hot chocolate, and more recently vitamin and electrolyte waters. The different beverages are packaged in cans, bottles, and/or cartons and come in an assortment of flavors.

With such a wide assortment of beverages and drinks available, especially mixed drinks or alcoholic beverages, a consumer would like the ability to sample or pre-taste the beverage prior to purchasing to determine if the consumer actually likes the taste of the beverage or drink. Moreover, since it is illegal to have an open container in a liquor store, thus prohibiting sampling of mixed drinks or alcoholic beverages, and a patron of a club or bar is obligated to purchase the entire drink to sample the drink the ability to sample or pre-taste the drink is prohibitive.

It is known to provide drink flavoring sticks and straws. In particular, known flavoring sticks such as hard candy sticks may be licked or used to stir a flavor into a drink to give the drink an added or new flavor or to sweeten such drink. The beverage is prepared by placing the hard candy stick in the beverage and allowing the hard candy stick to dissolve into the beverage. Moreover, the hard candy stick may be used to stir the beverage assisting in dissolving the flavoring or sweetener into the beverage. In addition, drink flavoring straws are known, and utilized to draw a liquid such as milk through the straw having self-contained inner flavor structures within the straw to impart dissolved flavoring or sweetener to the associated fluid as it is drawn through the straw.

Therefore, it is readily apparent that there is a recognizable unmet need for a drink sample apparatus and method of use thereof, wherein such drink stick enables a consumer to sample or pre-taste the drink or beverage before making the decision to purchase the entire drink or beverage or purchase the ingredients to make the drink or beverage.

### BRIEF SUMMARY

Briefly described, in example embodiment, the present apparatus overcomes the above-mentioned disadvantage, and meets the recognized need for a drink sample apparatus and method thereof, including in general, an elongated stick or member, a small sample mixture of a beverage or drink or oil extract of the same, an edible bond to affix or cover said small sample mixture of a beverage or drink to said stirring stick, and, thus, functions to enable a consumer to sample or pre-taste the drink or beverage before making the decision to purchase the entire drink or beverage or purchase the ingredients to make the drink or beverage.

According to its major aspects and broadly stated, the a drink sample apparatus and method thereof, in general, includes the following elements an elongated stick or member, an indicia of the drink mixture marked on said stick, a small mixture of a beverage or drink or oil extract of the same, an edible bond to affix said sample mixture of the beverage or drink to said stick that functions to provide a sample taste of a drink or beverage, such as an alcoholic beverage, before making the decision to purchase the drink or beverage.

In a preferred embodiment, the drink sample apparatus for use in taste testing by positioning on a user's tongue, the drink sample apparatus includes an elongated member, the member having a surface, a flavor sample disposed on the surface, and a thin film disposed on the surface, the thin film configured to cover the flavor sample.

In a further exemplary embodiment, the drink sample apparatus for use in taste testing by positioning on a user's tongue, the drink sample apparatus including an elongated member, the member having a surface, a flavor sample, and a thin film formed with the flavor sample integrated therein, the thin film disposed on the surface.

In still a further exemplary embodiment of the method of taste testing a sample beverage, by positioning on a user's tongue, before making a decision to purchase the beverage, the method including the steps of providing drink sample, the drink sample having an elongated member, the member having a surface, a flavor sample disposed on the surface, and a thin film disposed on the surface, the thin film configured to cover the flavor sample, selecting the drink sample, gripping the surface of the drink sample, positioning the flavor sample disposed on the surface on the user's tongue, tasting the flavor sample, and determining whether the user likes the flavor sample.

Accordingly, a feature of the drink sample apparatus and method thereof is its ability to enable the consumer/user the opportunity to sample or pre-taste any given drink or beverage before making the decision to purchase the entire drink or beverage or purchase the ingredients to make the drink or beverage.

Another feature of the drink sample apparatus and method thereof is its ability to function as a stirring stick to stir or evenly distribute the drink or beverage, especially a mixed drink or alcoholic beverage.

Still another feature of the drink sample apparatus and method thereof is its ability to enable the consumer/user the opportunity to sample or pre-taste any given drink or beverage to determine whether or not the consumer/user likes or dislikes the drink or beverage, especially a mixed drink or alcoholic beverage.

Still another feature of the drink sample apparatus and method thereof is its ability to provide indicia of the drink mixture marked on the sample apparatus to educate the consumer on the ingredients and/or quantities of a given drink or beverage, especially a mixed drink or alcoholic beverage.

Yet another feature of the sample apparatus and method thereof is its ability to provide indicia of the drink mixture marked on the sample apparatus to provide instructions to the drink mixer or consumer as to the ingredients, quantities, and/or step to make a particular drink or beverage, especially a mixed drink or alcoholic beverage.

Yet another feature of the sample apparatus and method thereof is its ability to provide indicia of the drink mixture marked on the sample apparatus to promote the sale of drinks or beverages, especially a mixed drinks or alcoholic beverages.

Yet another feature of the sample apparatus and method thereof is its ability to provide a method of affixing a sample or pre-taste portion of a drinks or beverages, especially a mixed drinks or alcoholic beverages to the apparatus.

Yet another feature of the sample apparatus and method thereof is its ability to provide a thin film or coating of gelatin, alginate, xanthan gum, guar gum, chitin, chitosin, gellan gum, agar, carrageenan, albumin, starch, carboxymethylcellulose (CMC), mixtures thereof, similar polymers, or the like to affix the sample or pre-taste portion of a drinks or beverages, especially a mixed drinks or alcoholic beverages to the apparatus.

These and other features of the drink sample apparatus and method of use thereof will become more apparent to one skilled in the art from the following Brief Description of the Drawings, Detailed Description, and Claims when read in light of the accompanying Drawings or Figures.

### BRIEF DESCRIPTION OF THE DRAWINGS

The present the drink sample apparatus and method of making and use thereof will be better understood by reading the Detailed Description of the embodiments with reference to the accompanying Drawing figures, which are not necessarily drawn to scale, and in which like reference numerals denote similar structure and refer to like elements throughout, and in which:

FIG. 1A is a top view of an example embodiment of a drink sample apparatus;

FIG. 1B is a side view of an example embodiment of a drink sample apparatus of FIG. 1A;

FIG. 2A is a top view of another example embodiment of a drink sample apparatus;

FIG. 2B is a side view of an example embodiment of a drink sample apparatus of FIG. 2A;

FIG. 3A is a top view of another example embodiment of a drink sample apparatus;

FIG. 3B is a side view of an example embodiment of a drink sample apparatus of FIG. 3A;

FIG. 3C is a side view of an example embodiment of a drink sample apparatus of FIG. 3A, shown with sealant strip partially removed;

FIG. 4A is a top view of another example embodiment of a drink sample apparatus;

FIG. 4B is a side view of an example embodiment of a drink sample apparatus of FIG. 4A;

FIG. 5A is a top view of another example embodiment of a drink sample apparatus;

FIG. 5B is a side view of an example embodiment of a drink sample apparatus of FIG. 5A;

FIG. 6 is a side view of a user tasting the contents of an example embodiment of a drink sample apparatus; and

FIG. 7 is a flow diagram of the steps of making a drink sample apparatus and for a user to sample taste a portion of any given drink or beverage before making the decision to purchase.

It is to be noted that the drawings presented are intended solely for the purpose of illustration and that they are, therefore, neither desired nor intended to limit the disclosure to any or all of the exact details of construction shown, except insofar as they may be deemed essential to the claimed invention.

### DETAILED DESCRIPTION

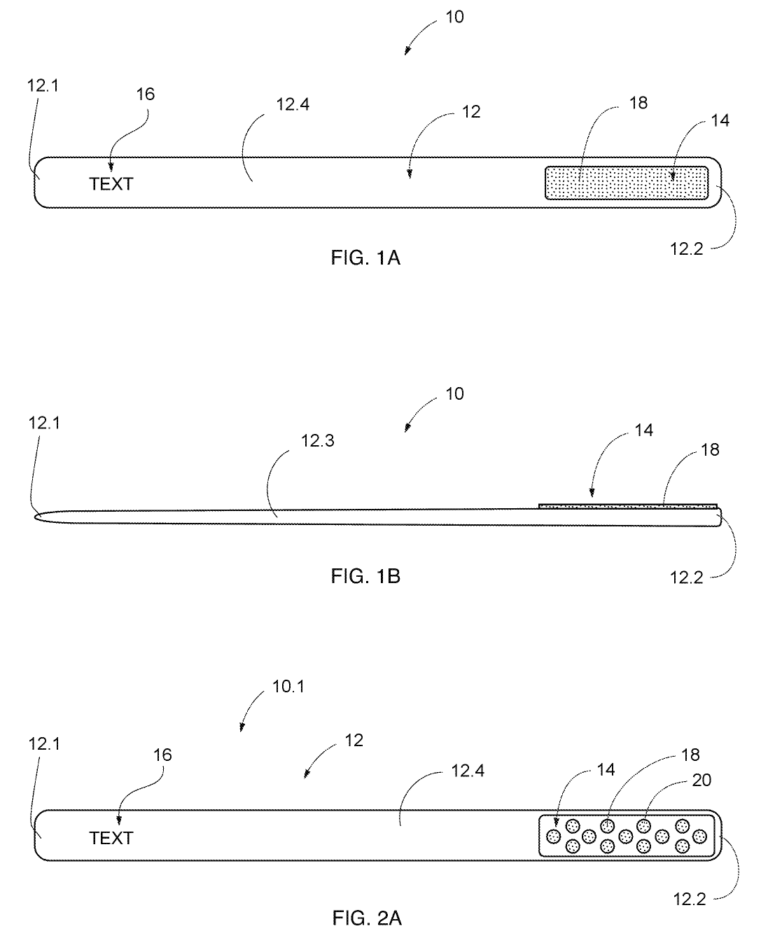

In describing the exemplary embodiments of the present disclosure, as illustrated in FIGS. 1-7, more specifically 1A, 1B, 2A, 2B, 3A, 3B, 3C, 4A, 4B, 5A, 5B, 6 and 7 specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to FIGS. 1A and 1B, by way of example, and not limitation, there is illustrated a top and side view of a Popsicle stick, stirring stick, drink taste test apparatus, or tasting stick, such as drink sample stick 10. Specifically, in FIGS. 1A and 1B, drink sample stick 10, preferably includes element, stick, or surface area, such as elongated member 12 having first end 12.1, second end 12.2, first side 12.3, and a surface, such as top side 12.4. It is contemplated herein that elongated member 12 may be configured in other shapes and sizes, including a disc or wafer. Elongated member 12 is preferably formed of a suitable rigid material, such as wood, plastic, metal, rubber, foam, or the like, capable of providing structure, taste testing, tongue contact, and beverage stirring capability to drink sample stick 10. Preferably, the material includes other suitable characteristics, such as durability, water-resistance, tastelessness, insoluble, light weight, heat-resistance, chemical inertness, oxidation resistance, ease of workability, or other beneficial characteristic understood by one skilled in the art. Moreover, elongated member 12 maybe configured as a stick, tube, rod, spoon, disc, wafer or other elongated configuration capable of providing structure, a surface, taste testing, tongue contact, and beverage stirring capability to drink sample stick 10. Elongated member 12 may be configured in a variety of lengths and configurations to function as a drink stirring stick and to function as a sample taste of a drink or beverage, such as an alcoholic beverage, and most preferably drink sample stick 10 may have a length between approximately four and approximately twelve inches. Other lengths are contemplated herein depending on the depth of the fluid or liquid to be stirred.

First end 12.1 of top side 12.4 of elongated member 12 preferably includes information, branding, trademark, instructions, especially drink preparation instructions, ingredients, recipe, and the like such as indicia 16 to provide promotional information, instructions to the drink mixer or consumer as to the ingredients, quantities, and/or preparation steps to make a particular drink or beverage, especially a mixed drink or alcoholic beverage and the like. The drink mixer, consumer, or purchaser preferably utilizes indicia 16 of drink sample stick 10 to purchase the listed ingredients, to prepare a particular drink or beverage from the listed ingredients by following the instructions set forth in indicia 16 for a particular drink or beverage, especially a mixed drink or alcoholic beverage.

Still further, first end 12.1 of elongated member 12 may be finger graspable, such as capable of being grasped between a user's thumb and finger to position drink sample stick 10 on a user's tongue, to position in a glass, to remove drink sample stick 10 from a glass and/or used as a stirring stick to evenly distribute the flavor of a particular drink or beverage, especially a mixed drink or alcoholic beverage.

Second end 12.2 of top side 12.4 of elongated member preferably includes coating, bonding agent, sealant, adhesive, layer, edible paper, thin strip, oral film, or edible film, such as thin film 14. Preferably, thin film 14 is composed of or based of gelatin, alginate, xanthan gum, guar gum, chitin, chitosin, gellan gum, agar, carrageenan, albumin, starch, carboxymethylcellulose (CMC), mixtures thereof, similar polymers, or the like capable of adhesion, covering, sealing, bonding, peeling, removal and/or dissolving on contact with heat or moisture, especially saliva from a user's tongue.

Moreover, second end 12.2 of top side 12.4 of elongated member 12 preferably includes a test sample or a taste portion of any drink or beverage, especially a mixed drink or alcoholic beverage, such as flavor sample 18. Preferably, flavor sample 18 is formed from a derivative of the actual ingredients of a specific drink or beverage in the form of dehydrated powder, crystalline, concentrate, distillate, extract, oil or the like, artificial flavors, or actual natural ingredients or combinations thereof in portions to provide an accurate taste or flavor sample of the specific drink or beverage, especially a mixed drink or alcoholic beverage. It is contemplated herein that flavor sample 18 and/or thin film 14 may include a preservative compound, such as citric acid or the like, to preserve freshness of flavor sample 18. It is further contemplated herein that flavor sample 18 may be integrated into thin film 14 by mixing. It is further contemplated herein that integrated flavor sample 18 and thin film 14 may be sold or used individualy or sold or used in multiples and made available in a dispenser, such as dissolving strip(s), shown in FIGS. 1A, 1B, and 3C as thin film 14 with integrated flavor sample 18.

### EXAMPLE 1

### Margarita Mixed Drink Flavor Sample 18

Tequila (containing sample flavor(s) comparable to Margarita levels, such as 6 parts)

Triple sec (containing sample flavor(s) comparable to Margarita levels, such as 2 parts)

Lime Juice (containing sample flavor(s) comparable to Margarita levels, such as 4 parts)

### EXAMPLE 2

### Whiskey & Cola Mixed Drink Flavor Sample 18

Whiskey (containing sample flavor(s) comparable to Whiskey & Cola levels, such as 4 parts)

Cola (containing sample flavor(s) comparable to Whiskey & Cola levels, such as 6 parts)

Included herein is any other exemplary drink or beverage, or more specifically mixed drink or alcoholic beverage set forth in a bartender's reference, such as The New York Bartender's Guide incorporated herein in its entirety by reference.

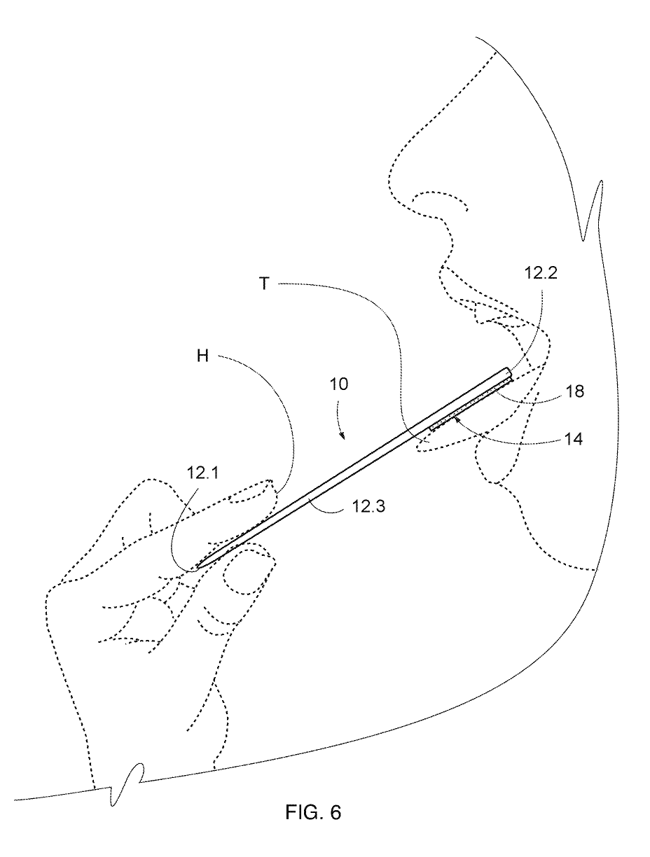

Referring again to FIGS. 1A and 1B, flavor sample 18 is preferably combined, integrated, or incorporated into thin film 14 and formed, disposed, or affixed to second end 12.2 of top side 12.4 of sample stick 10. It is contemplated herein that combination flavor sample 18 and thin film 14 may be positioned elsewhere on elongated member 12. In use, referring now to FIG. 6, first end 12.1 of elongated member 12 preferably may be positioned and grasped between a user's thumb and finger of hand H to position drink sample stick 10, especially to position second end 12.2 of top side 12.4 of elongated member 12, on a user's tongue T. Upon contact with user's tongue T, preferably thin film 14 dissolves on contact with the user's saliva or heat releasing flavor sample 18 on the user's taste buds of tongue T to enable user to taste flavor sample 18 and to determine whether or not the user likes or dislikes the represented drink or beverage of flavor sample 18, especially a mixed drink or alcoholic beverage.

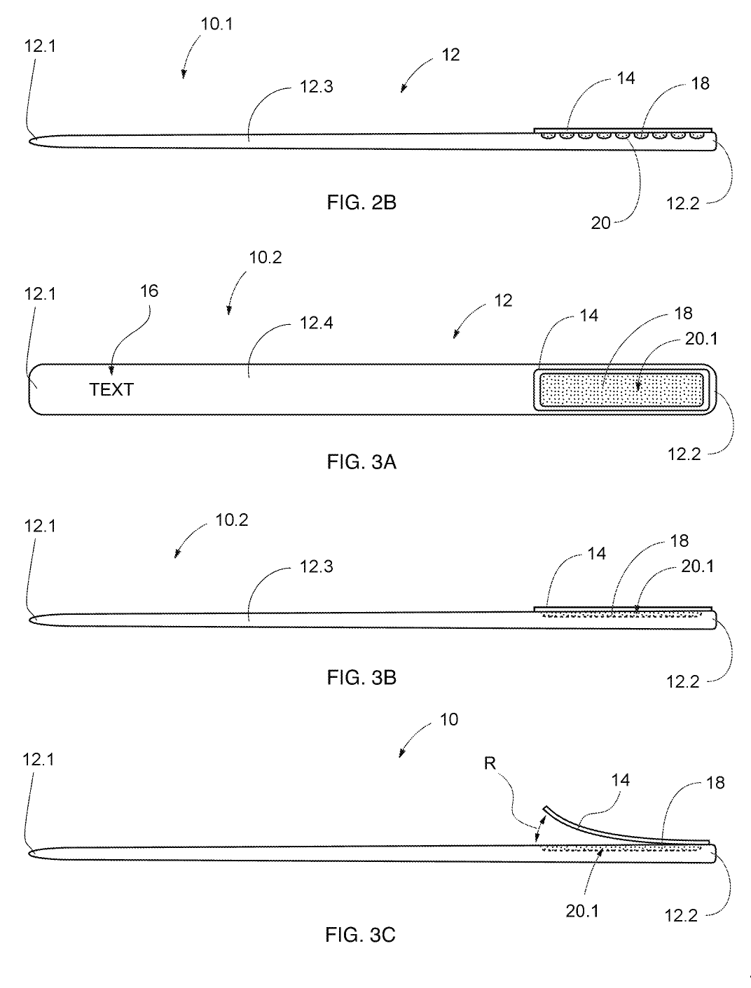

Referring now to FIGS. 2A and 2B, by way of example, and not limitation, there is illustrated a top and side view of an alternate exemplary embodiment drink sample stick 10.1. Specifically, in FIGS. 2A and 2B, drink sample stick 10.1, preferably includes one or more or a plurality of divots, nooks, reservoirs, or recesses, such as cavities disposed proximate second end 12.2 and formed or configured in top side 12.4 of elongated member 12. It is contemplated herein that cavities 20 may be positioned elsewhere on elongated member 12. Preferably cavities 20 are layered or filled with flavor sample 18 and one or more thin film 14 may be utilized to cover, seal or encapsulate cavities 20 filled with flavor sample 18, to preserve and prevent dehydration of flavor sample 18. It is contemplated herein that one or more thin film 14 may be affixed to top side 12.4 to cover, seal or encapsulate cavities 20. It is recognized herein that cavities 20 may be filled with flavor sample 18, such as Example 1, Example 2, or the like. In use, referring now to FIG. 6, first end 12.1 of elongated member 12 preferably may be positioned and grasped between a user's thumb and finger of hand H for positioning drink sample stick 10.1, especially second end 12.2 of top side 12.4 of elongated member 12, on a user's tongue T. Upon contact with user's tongue T, preferably thin film 14 dissolves on contact with the user's saliva on tongue T releasing flavor sample 18 from cavities 20 on the user's taste buds of tongue T to enable user to taste flavor sample 18 and to determine whether or not the user likes or dislikes the represented drink or beverage, especially a mixed drink or alcoholic beverage.

Referring now to FIGS. 3A, 3B and 3C, by way of example, and not limitation, there is illustrated a top and side views of an alternate exemplary embodiment drink sample stick 10.2. Specifically, in FIGS. 3A, 3B and 3C, drink sample stick 10.2, preferably includes divot, channel, furrow, cavity, reservoir, or recesses, such as trough 20.1 disposed proximate second end 12.2 of top side 12.4 of elongated member 12. It is contemplated herein that trough 20.1 may be positioned elsewhere on elongated member 12. Preferably trough 20.1 is layered or filled with flavor sample 18 and one or more thin film 14 may be utilized to seal or encapsulate trough 20.1 filled with flavor sample 18. It is contemplated herein that one or more thin film 14 may be affixed to top side 12.4 to cover, seal or encapsulate trough 20.1. It is recognized herein that trough 20.1 may be filled with flavor sample 18, such as Example 1, Example 2, or the like. In use, referring now to FIG. 6, first end 12.1 of elongated member 12 preferably may be positioned and grasped between a user's thumb and finger of hand H for positioning drink sample stick 10.2, especially second end 12.2 of top side 12.4 of elongated member 12, on a user's tongue T. Upon contact with user's tongue T, preferably thin film 14 dissolves on contact with the user's saliva on tongue T releasing flavor sample 18 from trough 20.1 on the user's taste buds of tongue T to enable user to taste flavor sample 18 and to determine whether or not the user likes or dislikes the represented drink or beverage, especially a mixed drink or alcoholic beverage.

It is contemplated herein that thin film 14 may be peeled off or removed R, as shown in FIG. 3C, prior to inserting and positioning second end 12.2 of top side 12.4 of elongated member 12 on a user's tongue T.

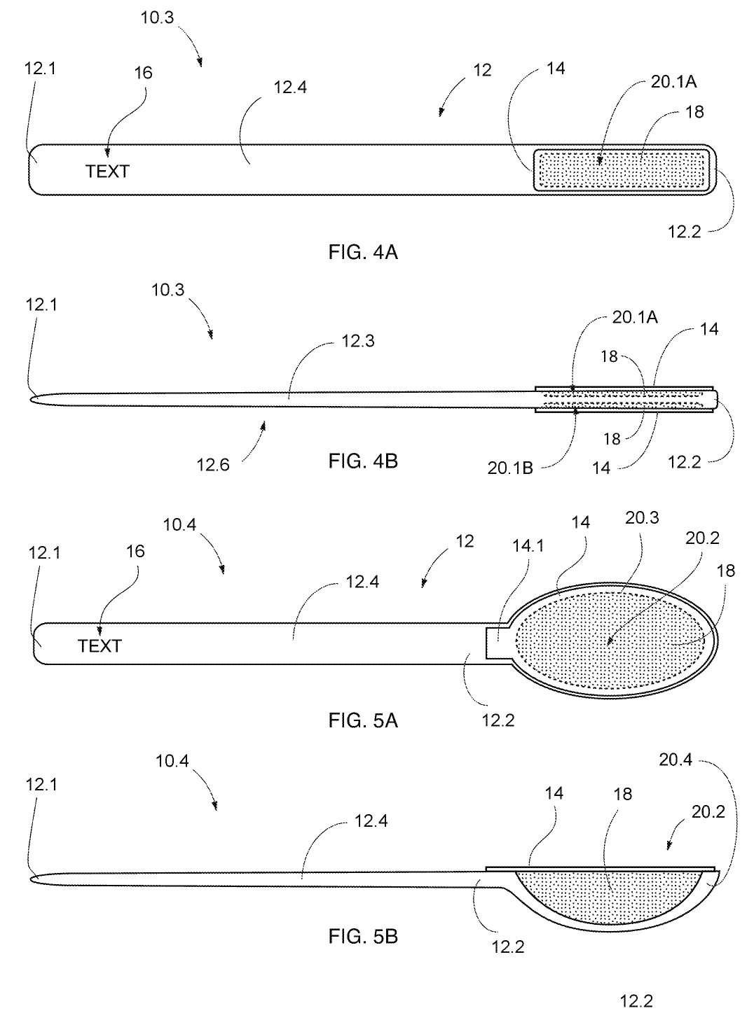

Referring now to FIGS. 4A and 4B, by way of example, and not limitation, there is illustrated a top and side view of an alternate exemplary embodiment drink sample stick 10.3. Specifically, in FIGS. 4A and 4B, drink sample stick 10.3, preferably includes divot, channel, furrow, cavity, reservoir, or recesses, such as trough 20.1A disposed proximate second end 12.2 of top side 12.4 of elongated member 12 and trough 20.1B disposed proximate second end 12.2 of underside 12.6 of elongated member 12. It is contemplated herein that trough 20.1A/B may be positioned elsewhere on elongated member 12. Preferably trough 20.1A and 20.1B is layered or filled with flavor sample 18 and one or more thin film 14 may be utilized to cover, seal, or encapsulate trough 20.1A and 20.1B filled with flavor sample 18. It is contemplated herein that one or more thin film 14 may be affixed to top side 12.4 and/or underside 12.6 to cover, seal, or encapsulate trough 20.1A and 20.1B. It is recognized herein that trough 20.1A may be filled with flavor sample 18, such as Example 1 and trough 20.1B may be filled with a different flavor sample 18, such as Example 2. In use, referring now to FIG. 6, first end 12.1 of elongated member 12 preferably may be positioned and grasped between a user's thumb and finger of hand H for positioning drink sample stick 10.3, especially second end 12.2 of top side 12.4 of elongated member 12, on a user's tongue T. Upon contact with user's tongue T, preferably thin film 14 dissolves on contact with the user's saliva or body heat on tongue T releasing flavor sample 18 from trough 20.1A/B on the user's taste buds of tongue T to enable user to taste flavor sample 18 and to determine whether or not the user likes or dislikes the represented drink or beverage, especially a mixed drink or alcoholic beverage.

It is contemplated herein that thin film 14 may be peeled off or removed R, as shown in FIG. 3C, prior to inserting and positioning second end 12.2 of top side 12.4 of elongated member 12 on a user's tongue T.

Referring now to FIGS. 5A and 5B, by way of example, and not limitation, there is illustrated a top and side view of an alternate exemplary embodiment drink sample stick 10.4. Specifically, in FIGS. 5A and 5B, drink sample stick 10.4, preferably includes a reservoir, cavity, or ladle, such as spoon 20.2 disposed proximate second end 12.2 of top side 12.4 of elongated member 12. It is contemplated herein that spoon 20.2 may be positioned elsewhere on elongated member 12. Preferably spoon 20.2 is layered or filled to fill line 20.3 with flavor sample 18 and one or more thin film 14 may be utilized to cover, seal, or encapsulate spoon 20.2 filled with flavor sample 18. It is recognized herein that spoon 20.2 may be filled with flavor sample 18, such as Example 1, Example 2, or the like. It is contemplated herein that one or more thin film 14 may be affixed to rim 20.4 of spoon 20.2 to cover, seal, or encapsulate spoon 20.2. In use, referring now to FIG. 6, first end 12.1 of elongated member 12 preferably may be positioned and grasped between a user's thumb and finger of hand H for positioning drink sample stick 10.4, especially second end 12.2 of top side 12.4 of elongated member 12, on a user's tongue T. Upon contact with user's tongue T, preferably thin film 14 dissolves on contact with the user's saliva on tongue T releasing flavor sample 18 from spoon 20.2 on the user's taste buds of tongue T to enable user to taste flavor sample 18 and to determine whether or not the user likes or dislikes the represented drink or beverage, especially a mixed drink or alcoholic beverage.

It is contemplated herein that thin film 14 may be peeled off or removed R by gripping and pulling tab 14.1, as shown in FIGS. 5B and 3C, prior to inserting and positioning second end 12.2 of top side 12.4 of elongated member 12 on a user's tongue T.

It is contemplated herein that elongated member 12 may be configured as various shapes other than the rectangle configuration shown.

It is contemplated herein that drink sample stick 10 may include a two ended flavor sample 18, as in flavor sample 18 positioned on second end 12.2 of elongated member and flavor sample 18 positioned on first end 12.1 of elongated member 12.

Referring now to FIG. 6, by way of example, and not limitation, there is illustrated a user of exemplary embodiment drink sample stick 10. In use, referring now to FIG. 6, first end 12.1 of elongated member 12 preferably may be positioned and grasped between a user's thumb and finger of hand H for positioning drink sample stick 10, especially second end 12.2 of top side 12.4 of elongated member 12, on a user's tongue T. Upon contact with user's tongue T, preferably thin film 14 dissolves on contact with the user's saliva or body heat on tongue T releasing flavor sample 18 from thin film 14 on the user's taste buds of tongue T to enable user to taste flavor sample 18 and to determine whether or not the user likes or dislikes the represented drink or beverage, especially a mixed drink or alcoholic beverage.

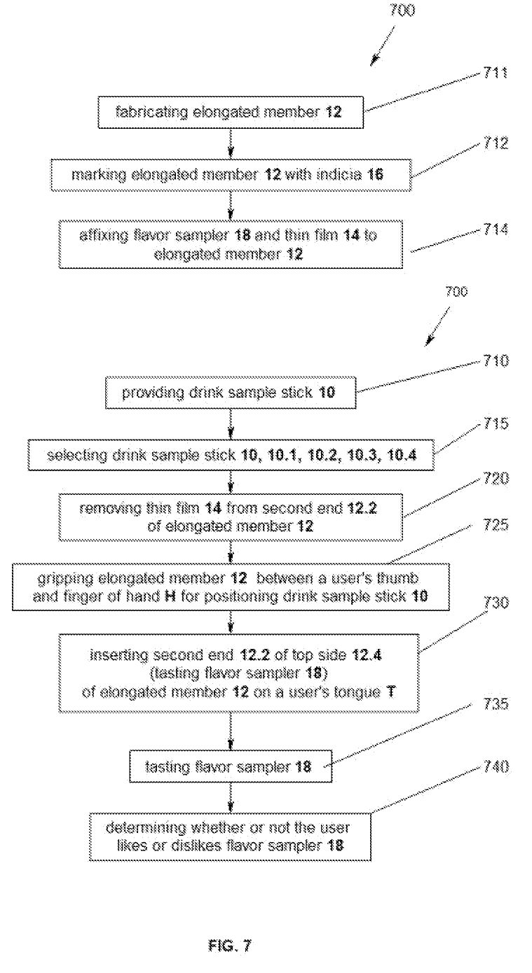

Referring now to FIG. 7, there is illustrated a flow diagram(s) 700 of a method of making drink sample stick 10 and/or taste testing drink sample stick 10 before making the decision to purchase the drink or beverage. In block or step 711, fabricating elongated member 12, as set forth herein in FIGS. 1-6. In block or step 712, marking elongated member 12 with indicia 16. In block or step 714, affixing flavor sample 18 and thin film 14 to elongated member 12 to form drink sample stick 10. In block or step 710, providing drink sample stick 10, 10.1, 10.2, 10.3, 10.4 or the like, as described above in FIGS. 1A, 1B, 2A, 2B, 3A, 3B, 3C, 4A, 4B, 5A, 5B, and 6 and steps 711, 712, 714. In block or step 715, selecting drink sample stick 10, 10.1, 10.2, 10.3, 10.4. In block or step 720, removing thin film 14 from second end 12.2 of elongated member 12, as shown in FIG. 3C to expose flavor sample 18. In block or step 725, gripping elongated member 12 between a user's thumb and finger of hand H for positioning drink sample stick 10. In block or step 730, inserting and/or positioning second end 12.2 of top side 12.4 of elongated member 12 on a user's tongue T. In block or step 735, tasting flavor sample 18 of drink sample stick 10, by a user. In block or step 740, determining whether or not the consumer/user likes or dislikes flavor sample 18. In block or step 745, making a drink or beverage purchasing decision based on the decision or information in step 740.

The foregoing description and drawings comprise illustrative embodiments of the present invention. Having thus described exemplary embodiments, it should be noted by those ordinarily skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one ordinarily skilled in the art to which this invention pertains having the benefit of the teachings presented in the foregoing descriptions and the associated drawings. Although specific terms may be employed herein, they are used in a generic and descriptive sense only and not for purposes of limitation. Moreover, the present invention has been described in detail, it should be understood that various changes, substitutions and alterations can be made thereto without departing from the spirit and scope of the invention as defined by the appended claims. Accordingly, the present invention is not limited to the specific embodiments illustrated herein, but is limited only by the following claims.

What is claimed is:

1. A drink sample apparatus for use in taste testing by positioning on a user's tongue, the drink sample apparatus comprising
an elongated member, said member having a surface;
a flavor sample disposed on said surface; and
a thin film disposed on said surface, said thin film configured to cover said flavor sample.

2. The drink sample apparatus of claim 1, wherein said thin film dissolves upon contact with user's tongue.

3. The drink sample apparatus of claim 2, wherein said dissolved thin film enables the taste testing of said flavor sample on the user's tongue.

4. The drink sample apparatus of claim 1, wherein said thin film is configured to be peeled off said surface to expose said flavor sample.

5. The drink sample apparatus of claim 1, further comprises an indicia.

6. The drink sample apparatus of claim 5, wherein said indicia is selected from the group consisting of promotional information, instructions, ingredients, recipe, quantities, preparation steps, branding, trademark, and combinations thereof.

7. The drink sample apparatus of claim 1, wherein said flavor sample further comprises a preservative compound to preserve said flavor sample.

8. The drink sample apparatus of claim 1, wherein said elongated member further comprises one or more cavities configured in said surface.

9. The drink sample apparatus of claim 8, wherein said cavities are filled with said flavor sample.

10. The drink sample apparatus of claim 9, wherein said cavities filled with said flavor sample are covered by said thin film disposed on said surface.

11. The drink sample apparatus of claim 1, wherein said elongated member further comprises at least one reservoir configured in said surface.

12. The drink sample apparatus of claim 11, wherein said reservoir is filled with said flavor sample.

13. The drink sample apparatus of claim 12, wherein said reservoir filled with said flavor sample is sealed by said thin film disposed on said surface.

14. A drink sample apparatus for use in taste testing by positioning on a user's tongue, the drink sample apparatus comprising
an elongated member, said member having a surface;
a flavor sample; and
a thin film formed with said flavor sample integrated therein, said thin film disposed on said surface.

15. The drink sample apparatus of claim 14, wherein said thin film dissolves upon contact with user's tongue.

16. The drink sample apparatus of claim 15, wherein said dissolved thin film enables the taste testing of said flavor sample on the user's tongue.

17. The drink sample apparatus of claim 14, further comprises an indicia.

18. The drink sample apparatus of claim 17, wherein said indicia is selected from the group consisting of promotional information, instructions, ingredients, recipe, quantities, preparation steps, branding, trademark, and combinations thereof.

19. The drink sample apparatus of claim 1, wherein said flavor sample further comprises a preservative compound to preserve said flavor sample.

20. A method of taste testing a sample beverage, by positioning on a user's tongue, before making a decision to purchase the beverage, the method comprising the steps of:
providing a drink sample, said drink sample having an elongated member, said member having a surface, a flavor sample disposed on said surface, and a thin film disposed on said surface, said thin film configured to cover said flavor sample;
selecting said drink sample;
gripping said surface of said drink sample;
positioning said flavor sample disposed on said surface on the user's tongue;
tasting said flavor sample; and
determining whether the user likes said flavor sample.

21. The method of claim 20, further comprising the step of purchasing the beverage based on a favorable tasting of said flavor sample.

22. The method of claim 20, further comprising the step removing said thin film from said surface to expose said flavor sample.
